(19) United States
(12) Patent Application Publication
(10) Pub. No.: US 2014/0151966 A1
(43) Pub. Date: Jun. 5, 2014

(54) DUAL SEALING ARRANGEMENT FOR FINAL DRIVE GEAR BOX

(71) Applicant: DEERE & COMPANY, Moline, IL (US)

(72) Inventors: Donald O. Johannsen, Dubuque, IA (US); Denis J. Roling, Dubuque, IA (US)

(73) Assignee: Deere & Company, Moline, IL (US)

(21) Appl. No.: 13/705,926

(22) Filed: Dec. 5, 2012

(51) Int. Cl. F16J 15/02

(52) U.S. Cl. CPC F16J 15/02
USPC 277/320; 277/628

(57) ABSTRACT

A final drive transmission includes concentric inner and outer metal face seals at an interface between fixed and rotating housing sections for preventing oil contaminating material from entering the housing. Each face seal includes identical metal face seal rings that are biased into sealing engagement with each by identical frusto-conical elastomeric rings. The metal rings are generally L-shaped in cross section, with the metal rings of the outer face seals being constructed to withstand extreme conditions by making their cross section approximately twice that of the inner metal rings. Together with interface surfaces, the assembled inner and outer face seals define a sealed cavity which contains lubrication oil. A reservoir of oil with an oil level sensor is coupled to the sealed cavity and in this way it is determined whether or not oil is leaking from the cavity so that steps may be taken to avoid a catastrophic failure.

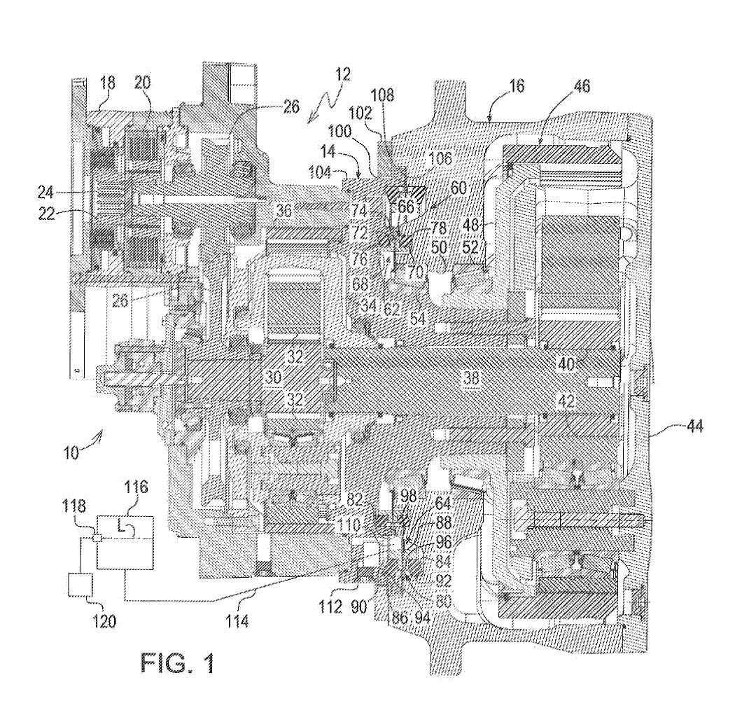

### FIELD OF THE INVENTION

The present invention relates to sealing arrangements for final drive gear transmission housings exposed to severe operating conditions.

### BACKGROUND OF THE INVENTION

Final drive transmissions, commonly referred to as final drives, for off-road equipment, such as industrial and agricultural tractors are designed with sealed housings for containing lubrication oil for various drive components located within the housings, but are often physically located in an area on the vehicle where it is difficult to detect whether or not the lubrication oil is leaking from the housings. When these final drives are operated in extreme cold weather, it is common for face seals provided for sealing the interface between fixed and rotatable sections of the housings to fail and to leak lubrication oil. No matter what causes a seal to fail, a final drive operated after the lubrication oil has leaked to a low level will often experience a catastrophic failure. This results in large repair costs and down time for the customer.

What is needed then is a robust seal arrangement for use in final drives and a way to easily detect an oil leak in the event that the seal arrangement fails and leaks.

### SUMMARY OF THE INVENTION

According to the present invention, there is provided an improved final drive seal arrangement having one or more features optimized to promote longer effective life together with a remote oil level sensing arrangement for detecting lubrication oil leakage.

The improved final drive seal arrangement includes an outer face seal assembly including a relatively large diameter annular recesses defining right angle elastomeric load ring seats, and a smaller similar inner face seal assembly located concentric to the larger outer face seal assembly so as to define a sealed lubrication oil cavity between the outer and inner face seal assemblies, with the outer face seal assembly including at least one of the following optimized features:
a) each elastomeric load ring being frusto-conical and having a dirt excluder lip engaging the OD of the associated metal seal ring to prevent material from entering into the sealed area between the load ring and metal seal ring;
b) anti-rotation lugs to prevent the metal ring from rotating relative to the associated elastomeric load ring member;
c) sealing ribs at the OD of the elastomeric load ring member to prevent material from being forced between the load ring and its seat and down into the seal cavity; and
d) heavy section metal face seal ring members for withstanding forces created during extreme operating conditions.

The sealing arrangement may further include an oil reservoir with an oil level sensor coupled to the lubrication oil cavity and may include a flush port coupled to the sealed lubrication oil cavity.

### BRIEF DESCRIPTION OF THE DRAWINGS

The sole FIGURE is a sectional view taken through a final drive transmission housing and showing the sealing arrangement for forming an annular lubrication oil cavity to which is coupled a remote lubrication oil reservoir having an oil level sensor.

### DESCRIPTION OF THE PREFERRED EMBODIMENT

Referring now to the drawing, there is shown a longitudinal sectional view of a final drive gear housing 10 forming one of a pair of final drive gear housings of an off-road machine (not shown). The final drive gear housing 10 comprises a split housing including a fixed housing section 12 having a rightward portion defined by a spindle 14, and a rotatable housing section defined by a wheel hub 16.

As viewed in the drawing, an upper left region of the fixed housing section 12 defines a brake housing 18 containing a stack of brake discs 20, some of which are mounted to the housing 18 for shifting axially and are interleaved with other discs coupled to an exterior of an enlarged right end region of an input collar for rotation with an input collar 22 having an internal end region formed with splines 24 adapted for connection to a splined end of an input shaft (not shown), the input collar having an internal right end region provided with splines coupled for to a externally splined left end region of a shaft forming a left end continuation of a hub of an input gear 26. The input gear 26 is meshed with a gear 28 received on, and fixed for effecting rotation of, a shaft forming a left extension of a sun gear 30 meshed for driving planet gears 32 carried by a planet carrier 34, the planet gears 32 being meshed with teeth of a ring gear 36 surrounding the carrier 34. The carrier 34 is coupled to a left end region of an output shaft 38 disposed in axial alignment with, and rotatably supporting a stub shaft formed at a right side of the sun gear 30. The output shaft 38 is located centrally within and extends axially through the spindle 14. A right end region of the output shaft 38 has a sun gear 40 received thereon for being driven by the shaft, the sun gear 40 being meshed with planet gears 42 mounted to a carrier 44 defined by a right end plate of the wheel hub 16. The planet gears 40 are meshed for traveling about internal teeth of a ring gear 46 having a hub 48 received on and fixed to an exterior right end region of the spindle 14.

The wheel hub 16 includes a thick left side region provided with a central opening 50 having right and left regions into which outer races of identical right and left roller thrust bearings 52 and 54 are respectively pressed, the inner races of the bearings 52 and 54 being respectively pressed onto that portion of the ring gear hub 48 which is mounted on the right end region of the spindle 14 and onto an annular shoulder of the spindle 14. Thus, the bearings 52 and 54 serve to mount the wheel hub 16 for rotation about the longitudinal axis of the output shaft 38, noting that the hub 16 is driven in rotation by the output shaft 38 acting through the planetary gear set 40, 42 and 46 which causes rotation of the carrier 44 and hence the wheel hub 16 which includes the carrier.

The spindle 14 includes a left end region that extends radially outwardly just to the left of the left thrust bearing 54 and that includes an annular right surface disposed in confronting relationship to a left surface of the wheel hub 16. This right surface of the spindle 14 and left surface of the wheel hub 16 thus define an interface region that is located radially outward of the left thrust roller bearing 54, and provided for sealing this interface to prevent leakage of lubrication oil surrounding the bearing 54 and prevent debris from entering from outside the gear housing and contaminating the lubrication oil contained within the gear housing 10 for lubricating the various gears and bearings located within the housing is a sealing arrangement 60. The sealing arrangement 60 includes an inner face seal assembly 62 that provides a secondary seal to maintain proper oil level in final drive housing 10 for lubricating the various gear sets and bearings located within the housing, and an outer face seal assembly 64 that is exposed to, and provides a primary seal for preventing external material, including abrasive particulate matter, for example, from entering the housing 10. The inner and outer face seal assemblies 62 and 64, respectively, each comprise right and left identical elements arranged as mirror images of each other.

Specifically, the inner face seal assembly 62 is located in an inner annular seal cavity 66 located just radially outward of the left thrust roller bearing 54. The seal assembly 62 comprises an inner left annular recess 68 provided in a rightward facing surface of the spindle 14 and a right inner annular recess 70 provided in a leftward facing surface of the hub 16. The inner face seal assembly 64 includes identical left and right metal face seal rings 72 and 74, respectively, located mostly within the right and left inner annular recesses 68 and 70. The seal rings 72 and 74 are L-shaped in cross section and each has radial and axially extending legs joined together so as to define an inner right-angular seat, respectively for inner ends of left and right frusto-conical elastomeric load rings 76 and 78, with outer ends of the left and right load rings being respectively seated in left and right outer right-angular seats respectively defined by radial and axial wall surfaces of each of the left and right recesses 68 and 70. The elastomeric load rings 76 and 78, when installed as illustrated, are compressed between their respective inner and outer seats and act so as to exert a biasing force keeping annular sealing surfaces of the metal seal rings in sealed engagement with each other. Further, each of the elastomeric load rings 76 and 78 also performs a sealing function.

The outer face seal assembly 64 is located in an outer annular seal cavity 80 located radially outward of the inner seal cavity 66 and joined thereto by an annular connecting passage 82 defined by a clearance gap between confronting planar interface surfaces respectively of the fixed spindle 14 and the rotatable wheel hub 16. The outer annular seal cavity 80 comprises an outer right annular recess 84 provided in a leftward facing surface of the rotatable wheel hub 16, and a left outer annular recess 86 provided in a rightward facing surface of the fixed spindle 14. The outer face seal assembly 64 includes identical right and left metal face seal rings 88 and 90, respectively, located mostly within the right and left outer annular recesses 84 and 86. The metal face seal rings 90 and 92 are L-shaped in cross section and each has radial and axially extending legs joined together so as to define an inner right-angular seat. Respectively seated against the right angular seats of the face seal rings 90 and 92 are inner ends of right and left frusto-conical elastomeric load rings 92 and 94, with outer ends of the load rings 92 and 94 being respectively seated in right and left outer right-angular seats respectively defined by radial and axial wall surfaces of each of the right and left outer recesses 84 and 86. When installed, as illustrated, the load rings 92 and 94 are compressed between their respective inner and outer seats and act to exert a biasing force keeping the annular sealing surfaces of the metal seal rings 88 and 90 in sealed engagement with each other. The elastomeric load rings 92 and 94 include respective annular sealing lips 96 and 98, respectively, that are in engagement with outer annular surfaces defined by the radial legs of the metal face seal members 88 and 90, the lips performing a sealing function preventing debris from moving between the load rings 92 and 94 and the radial legs of the associated metal face seal rings 88 and 90.

The outer annular seal cavity 80 is exposed to the outside environment by a labyrinth or stepped annular path 100 having an outer section defined by a gap between an inner diameter of an annular ring 102 and an annular outer surface 104 of the spindle 14. The ring 102 has an annular outer right face portion fixed against a complementary left surface region of the hub 16, which joins a stepped recess 106 of the hub. The spindle 14 has an annular flange 108 joined to the annular surface 104 and having a left surface spaced from an inner right surface region of the ring 102 so as to define a first intermediate section of the path 100, having an outer annular surface spaced from one wall of the stepped recess 106 to define a second intermediate section of the path 100, and having a right face spaced from a second wall of the stepped recess 106 so as to define an inner section of the path 100 that ends at the outer seal cavity 80.

In the event that external material does make its way to the seal cavity 80 by way of the path 100, the seal lips 96 and 98 will tend to prevent the material from making its way between mating surfaces of the elastomeric load rings 92 and 94 and the metal face seals 88 and 90, noting that the presence of such material has the deleterious effect of rigidifying the action of the elastomeric load rings so that they do not effectively keep the metal face seal rings 88 and 90 properly sealed against each other, especially in severe operating conditions in very cold weather. Also, it is noted that the outer metal face seal rings 88 and 90 are specially constructed to withstand forces created during operation in such severe working conditions by making them more rigid by increasing their cross section, here done by making the cross section of their axial legs approximately twice that of their horizontal legs, the area of the cross section of the outer metal face seal rings 88 and 90 being about twice the area of the cross section of the inner metal face seal rings 72 and 74.

An annular sealed cavity 110 is defined between the inner and outer face seal assemblies 62 and 64, respectively, and an external port, containing a threaded plug 112, is connected to the sealed cavity 110 and provides access for flushing and cleaning the cavity.

Also coupled to the sealed cavity 110, as by an oil line 114, is an oil reservoir 116 containing oil to a full level L. An oil level sensor 118 located in a side of the reservoir 116 for sensing when the oil level has fallen below the full level L, which indicates that the volume of oil in the cavity 110 has decreased indicating that leakage from the cavity 110 has occurred through at least one of the inner and outer face seal assemblies 62 and 64. The sensor 118 can be of any known type for completing an electrical circuit or generating an electrical signal for energizing a visual and/or audible warning device 120 to notify an operator of the fact that oil is leaking from the cavity 110.

In operation, the larger outer seal assembly 64 will be the most likely to fail due to it being exposed to extreme operating conditions. However, if either of the inner and outer seal assemblies 62 and 64 starts to leak, oil will be lost from the annular oil cavity 110 defined between the seal assemblies 62 and 64, with this lost oil being immediately replaced by oil from the reservoir 116. Thus, the oil level in the reservoir 116 will begin to recede from the full level L, with the oil level sensor 118 acting to initiate an energization of the warning device 110 so that an operator is apprised of leakage prior to the amount of leaked oil being of such quantity as to result in a catastrophic failure of gears and/or bearings contained in the final drive housing 10.

Although the outer seal assembly 64 is constructed robustly and the stepped passage 100 leading to the seal assembly 64 is sized, so as to minimize external material being forced through the outer seal assembly 64 during operation, some external material will be forced through the outer seal assembly 64. When this happens, the material forced through the outer seal assembly 64 will become collected and trapped in the annular oil cavity 110. The threaded plug 90 can periodically be removed to permit this trapped material to be flushed from the cavity 110 before it can pass through the inner face seal assembly 62 to the interior of the final drive housing 10 and damage gears, bearings, etc.

Having described the preferred embodiment, it will become apparent that various modifications can be made without departing from the scope of the invention as defined in the accompanying claims.

The invention claimed is:

1. In a final drive transmission including a housing defined by a fixed section and a rotatable section, a hearing arrangement supporting the rotatable section on the fixed section for rotation about a rotation axis, with the fixed and rotatable sections having adjacent fixed and rotating interface surfaces, and a sealing arrangement including inner and outer face seal assemblies mounted to the interface surfaces in concentric relationship to said rotation axis and defining an annular sealed cavity between them for containing lubrication oil, with the outer face seal assembly acting for preventing the ingress of debris from a work environment into the sealed cavity, a the improvement comprising:
said inner and outer face seals each including a pair of frusto-conical load rings respectively engaged with a pair of metal face seal rings and compressed between the housing and the pair of metal face seal rings so as to maintain the face seal rings in sealing engagement with each other; and
said pair of metal face seal rings of said outer face seal assembly each having a cross section having an area which is approximately twice the area of the cross section of each metal face seal ring of the inner face seal assembly.

2. The final drive transmission, as defined in claim 1, and further including a remote oil reservoir coupled to said annular cavity and adapted to contain oil to a predetermined full level;
an oil level sensor associated with said reservoir and being responsive to at least sense when the oil level drops below said full level to a second oil level indicative of oil having leaked from said annular cavity; and
said oil level sensor being operative, when sensing that the oil level in said reservoir is at said second level, for one of either sending an electrical signal energizing a warning device, or of completing an electrical circuit energizing a warning device.
